(19) United States
(12) Patent Application Publication
(10) Pub. No.: US 2007/0263797 A1
(43) Pub. Date: Nov. 15, 2007

(54) Dial pulse detection method and detector

(75) Inventors: Mark Raifel, Ra'anana (IL); Eli Shoval, Rosh Ha'ayin (IL)

Correspondence Address: EMPK & SHILOH, LLP, 116 John St., Suite 1201, New York, NY, 10038, US

(73) Assignee: Audiocodes Ltd., Lod (IL)

(21) Appl. No.: 11/410,510

(22) Filed: Apr. 25, 2006

(51) Int. Cl. H04M 1/64

(52) U.S. Cl. 379/88.01

(57) ABSTRACT

A method apparatus and system are provided for detecting pulses in a received signal wherein the spacing between the pulses may alternate in an expected manner. Generally, the method exploits intrinsic characteristics in the ensemble pulses, by performing correlation between pulses in a data stream representative of the received signal. Pulses may be related to an ensemble of pulses if their correlation result complies with a predefined criteria and the spacing between the correlated pulses is substantially the expected spacing. The correlation may be performed between two successive pulses, or it may be performed between non-successive pulses. The pulses may be alternating “start” and “stop” pulses of telephonic dial (rotary) pulses, and the expected spacing between the pulses may alternate between two values, “break” period and “make” period. Pulses may be correlated if their energy exceeds a predefined threshold value. The pulses may be interpreted to corresponding dialed digit, and a signal representative of the dialed digit may be forwarded to an IVR-enabled system.

### FIELD OF THE DISCLOSURE

The present disclosure relates generally to the field of telephone-driven services. More specifically, the present disclosure relates to a circuit and method for detecting dial pulse digits generated by a telephone dial actuator. The present disclosure also relates to a dial pulse detector.

### BACKGROUND

Telephone systems provide many types of telephonic services to subscribers, some of which involve, or require, use of interaction voice response (“IVR”) enabled and/or compatible systems. IVR systems have been designed to provide verbal commands and menus to a user who may typically respond to them, for example by using a dual-tone multi-frequency (“DTMF”) telephone set. DTMF, also known as Touch Tone or Tone Dialing, is used for telephone signaling to a call switching center over the line in the voice frequency band. Commonly, DTMF is used for most call setup to a telephone exchange, especially in the Western world. For each dialed character or symbol used by a DTMF telephone, the DTMF type telephone set generally generates and outputs a unique pair of dial tones whose frequency slightly differs from one another. Such pairs of dial tones are relatively easily detectable by IVR systems since detecting a signal of expected frequency is relatively simple. More specifically, pairs associated with each character and symbol are known to IVR systems/call centers. Once an IVR system detects a pair of dial tones and identifies the character or symbol associated with that pair, the IVR system may provide to the user or render the user with a corresponding service.

However, there are still in use telephone sets that generate dial pulses, rather than dial tones (DTMF). Exemplary telephone sets (generally referred to hereinafter as a dial pulse telephone set) that generate dial pulses are telephone set called rotary dials. A rotary dial is a device mounted on or in a telephone or switchboard that is designed to send interrupted electrical pulses, known as pulse dialing, which correspond to the number dialed. Rotary dials, which are less advanced than DTMF telephone sets, generate dial pulses instead of pairs of dial tones. Dial pulses relate to dialed digits, which may indicate a telephone number of a called party, character or to a symbol. Dial pulse telephone users are often incapable of responding to queries from IVR systems because of the problematic nature of dial pulses, as described hereinafter. In operation, a dial type telephone set generates a signal usually by the making and breaking of a switch in the telephone in a way that each dialed digit is uniquely represented by a corresponding number of pulses. The rate of the pulses, for example in pulses per second (“PPS”), is substantially constant, or at least similar, for each dialed digit.

In general, a telephonic communication, or call, typically includes two phases. The first phase includes identification of the calling and called parties by a telephone exchange system (“TES”). In the field of telecommunications, a TES usually contains, includes or houses, equipment that is commonly known in the field as a telephone switch, which is a piece of equipment that connects phone calls. It is what makes phone calls work in the sense of making connections and relaying the speech, and possibly other types of information or data. At the first phase, the TES, or telephone switch, identifies a number dialed by a calling party and accordingly interconnects the calling and called parties, whereby to establish a communication path. Once interconnected, a second phase takes place, during which a voice path is opened between the calling and called parties.

In cases where the calling party uses a dial pulse telephone set, lifting the handset from the telephone base commences a direct current (“DC”) current loop between the dialing telephone and a local telephone exchange system, which is opened (by being braked) and closed (by being made) by the dialing telephone to produce dialing pulses. Using a DC current loop allows the telephone switch to easily identify dialed pulses and, therefore, the dialed digits/number. However, once a voice path is opened between a dial pulse telephone set and an IVR system, sending dial pulses from the telephone set to the IVR system (in response to a verbal commend or menu of the IVR system) is problematic.

In part, the problem lies in that there is no DC current loop between the telephone set and the IVR system, which makes impossible for the IVR system to identify a dialed response in the prior-known manner. Secondly, because the dial pulse signal passes now through a voice path, from the telephone set to the IVR system, the shape of the dial pulses becomes severely corrupted. Dial pulses get severely corrupted, among other reasons, because the voice path, which typically has a bandwidth of approximately 3 KHz (for example 300 Hz to 3,300 Hz), acts as a band pass filter (“BPF”) that filters out much of the spectral content of the dialed pulses. The term “spectral content of a signal” generally refers to the frequency components which constitute the signal. The shape of a wave is directly related to the particular frequencies, amplitudes and phases of its components. In order to maintain the original shape of a signal while it traverses from one device to another, over some (hardwired or wireless) communication path, all of its original frequency components must reach the remote device while maintaining their relative magnitudes. However, if at least one frequency component does not reach the remote end, or its magnitude is severely attenuated, then the signal arriving at the remote end will be deformed (distorted). The more frequency components are severely attenuated, the more distorted the signal becomes at the remote end. Because of the BPF, the dialed pulses appear at the called party (the IVR system, for example) as an ensemble, or “train”, of transient pulses, the occurrence instant of which corresponds, or correlates, to the opening and closing instants of the switch generating the dial pulse.

Each cycle, or interval, of an individual dial pulse consists of one break period followed by one make period. The break and make periods of a particular telephone system depend on standards adopted for the telephone system. For example, a 100 milliseconds (msec.) cycle of an individual dial pulse may have make and break periods that are about 33.33 msec. and 66.66 msec. wide, respectively, and the pulse rate may be about 10 PPS. Any dialed digit will generate break and make periods that are relatively constant, but these periods may slightly vary from one telephone to another and/or from one telephone connection, or voice channel, to anther. At times, noise signals on the communication path may be more energetic than the pulses that are received at the called party, which may further exacerbate the detection reliability of dialed pulses.

In trying to cope with the problems described hereinbefore, some dial pulse detection systems have been designed for detecting dialed pulses, such as by comparing the energy of the received signal to an energy threshold value. Namely, a pulse is suspected as belonging to a dialed digit if its energy exceeds a threshold value. That is, if dial pulses are expected to have a minimal energy value of, say, X, than an energy threshold value is preset, which is slightly lower than X, for ensuring detection of substantially all dialed pulses and rejection of at least most of the noise. However, noises may be, at times, more energetic than the preset energy threshold level and, consequently, noises may be mistakenly regarded as dialed pulses.

More advanced dial pulse detection systems use some kind of training or learning process. Using such a process allows the dial pulse detection system of the called party to recognize or learn the characteristics of a specific telephonic connection over which the call is made. Training or learning process may start, for example, by requesting the calling party to dial a specific digit, or a combination of digits, prior to rendering services. In this type of conduct, the dial pulse detector “knows” in advance which digit(s) is/are going to be dialed, which therefore allows the detector to learn how the specific communication's path affects known dialed pulses. Secondly, this type of conduct implies that such detectors require several pulses to learn the characteristics/parameters of the communication path. Such a conduct may annoy the telephone operator because he would have to respond to commands that have nothing to do with the service that he requires.

Another problem associated with dialed pulses is that the characteristics of their related transient pulses may be connection-dependent. That is, their characteristics may change from one telephone connection to another, for example because of the different switchboards and communication length that may be involved in making a specific connection. In addition, some telephone connections may be noisier than others. Therefore, learning procedures are often employed per telephonic interaction or conversation.

Therefore it is an object of this disclosure to provide a pulse detection method and circuit for generally detecting an ensemble of pulses, within which a basic pattern may repeat.

Another object of this disclosure is to provide a detector for detecting dial pulses produced on a telephone line without requiring an extrinsic (in respect of the signal containing the ensemble pulses) reference signal, data or template.

It is yet another object of this disclosure to provide a method for detecting dial pulses without using preamble, learning or training session(s).

It is a further object of this disclosure to provide a dial pulse detector which is capable of cooperating with an interactive voice response enabled, or interactive voice response compatible system.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

The term “ensemble of pulses” (sometimes hereinafter “ensemble pulses”) generally means hereinafter a collection of pulses that may constitute, or uniquely relate to, one information unit. Regarding dial-type (rotary) telephone systems, a specific ensemble of pulses may relate to transient pulses originating from a specific dialed digit, character or symbol. Whenever an ensemble of pulses, or ensemble pulses, is/are said to be associated with a dialed digit, it is meant “dialed digit” or “dialed character” or “dialed symbol”, as may be appropriate according to the circumstances.

As part of the present disclosure a method is provided for detecting a plurality of pulses within a data stream that represent a received signal. The method may include cross-correlating two substantially adjacent correlation windows. Each correlation window may be adapted and temporally moved so as to be associated with a pulse within the received signal. The correlated pulses may belong to an ensemble of pulses.

As part of the present disclosure, a method is provided for detecting ensemble pulses in a received signal, wherein the temporal spacing between the ensemble's pulses may alternate in an expected manner. The ensemble of pulses may be detected by exploiting intrinsic characteristics of the ensemble pulses.

According to some embodiments the method may comprise performing one or more correlation(s) between pulses in the received signal and relating pulses to the ensemble if their lowest correlation value meets a predefined condition or criteria. The predefined condition or criteria may be the lowest correlation value being lower (more negative) than a predefined negative threshold value, or the resulting lowest correlation value lying within a predefined negative range, and the spacing between the pulses being correlated is the expected spacing. The predefined threshold value may be set to be between a lower limit and a higher limit. Alternatively, the threshold value may be dynamically and automatically changed, or adapted, to monitored conditions of the communication path. Alternatively, the predefined condition or criteria may be a highest correlation value being higher (more positive) than a predefined positive threshold value, or the resulting highest correlation value lying within a predefined positive range. Using lowest or highest correlation value depends on which pulses are correlated, as exsplained in connection with FIGS. 2b and 2c.

According to some embodiments the correlation may be performed between each of two successive pulses. According to some other embodiments the correlation may be performed between a detected ensemble pulse and other pulses, often more than one other pulse, wherein the detected ensemble pulse may be the first detected ensemble pulse. For example, the rotary number 1 would typically have one dial pulses (2 ensemble pulses), the number 2 would have two dial pulses (4 ensemble pulses), the number 8 would have eight dial pulses (16 ensemble pulses) with correlation performed between the first and second ensemble pulses, second and third ensemble pulses, and so on, up to the 15^{th} and 16^{th} ensemble pulses being correlated.

According to some embodiments the ensemble pulses may be alternating “start” and “stop” pulses that represent telephonic dialed pulses, and the expected spacing between the ensemble pulses may alternate between two values, break period (t1) and make period (t2).

According to some embodiments correlation may be performed between two pulses within a temporal window, the width of which may be defined by a low boundary (lₘᵢₙ) and a high boundary (lₘₐₓ), where lₘᵢₙ<t1<lₘₐₓ, or lₘᵢₙ<t2<lₘₐₓ, depending on which pulses are to be correlated, and the difference lₘₐₓ−lₘᵢₙ is some tolerance near or around the expected spacing (for example, t1 and t2). According to some embodiments pulses are correlated only if their energy level exceeds a predefined threshold value, or their energy level lies within a predefined range. Alternatively, the threshold level, or range may be adapted, or adjusted, to conditions of the communication path.

As part of the present disclosure, a dial pulse detector is provided for detecting a one or more dial pulses within a data stream representing a received signal, by detecting an ensemble of pulses that relate to the one or more dial pulses. The dial pulse detector may include a controller that is adapted to cross-correlate two substantially adjacent correlation windows.

As part of the present disclosure, the dial pulse detector is provided for detecting an ensemble of pulses in a received signal that may include noise (either constant, periodic, occasionally, intermittently or pulses) wherein the spacing between the ensemble pulses alternate in an expected manner. The dial pulse detector may include a sampling unit for sampling a received signal and a buffer memory for storing therein samples of the received signal. The dial pulse detector may further include a first-in-first-out (“FIFO”) type memory for storing in a first and second portion thereof a preferred number of samples that are to be correlated by a correlator. The correlator may correlate between samples in the first portion to samples in the second portion of the FIFO. The dial pulse detector may further comprise a controller for controlling the buffer, FIFO and correlator for enabling the correlation and relating pulses to the ensemble if their correlation result meets a predefined condition or criteria, and the correlation result is obtained for a temporal distance (l) between the correlated pulses which resembles the spacing expected for the correlated pulses. Alternatively, the correlation threshold value may be dynamically and automatically changed, adapted to or adjust according, to prevailing conditions of the communication path.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates a general telephone system;

FIG. 2a (prior art) depicts an examplary waveform of idealized dial pulse signal;

FIG. 2b depicts an ensemble of pulses that corresponds to the dial pulses of FIG. 2a;

FIG. 2c depicts exemplary correlation results in connection with the signal of FIG. 2b;

FIG. 2d exemplifies the energy of the signal of FIG. 2b;

FIGS. 2e and 2f depict start and stop pulses, “T” and “l”, respectively;

FIG. 3 is an exemplary block diagram which shows the general layout and functionality of an ensemble pulses detector according to some embodiments of the present disclosure;

FIG. 4 schematically illustrates an exemplary correlator; and

FIG. 5 schematically illustrates an interactive terminal equipment according to some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification terms such as “processing”, “computing”, “calculating”, “determining”, or the like, refer to the action and/or processes which may be performed by or on a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The disclosure may take the form of an entirely hardware embodiment, an entirely software embodiment or an embodiment containing both hardware and software elements. In a preferred embodiment, the disclosure is implemented in software, which includes but is not limited to firmware, resident software, microcode, or the like, which may be processed on a microprocessor or microcontroller.

Embodiments of the present disclosure may include apparatuses for performing the operations described herein. This apparatus may be specially constructed for the desired purposes, or it may comprise a general purpose computer selectively activated or reconfigured by a computer program stored in the computer.

Furthermore, the disclosure may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium or the like. Examples of a computer-readable medium include a semiconductor or solid state memory, magnetic tape, magnetic-optical disks, a removable computer diskette, a random access memory (RAM), a read-only memory (ROM), a rigid magnetic disk, an optical disk, electrically programmable read-only memories (EPROMs), electrically erasable and programmable read only memories (EEPROMs), magnetic or optical cards, or any other type of media suitable for storing electronic instructions, and capable of being coupled to a computer system bus.

Throughout the description that follows, it is assumed that a dial pulse telephone, after lifting the handset, transmits to a (local) TES a DC signal, and a dial pulse is generated by “breaking” the DC signal and “making” the DC signal again, in a number of times that corresponds to the dialed digit. However, in cases where the generation of pulses is implemented by making the DC signal (rather than by breaking it) and, thereafter, breaking it (rather than by making it), the wording “make period” should replace the wording “break period”, and vice versa, and the rest of the disclosure should be construed accordingly.

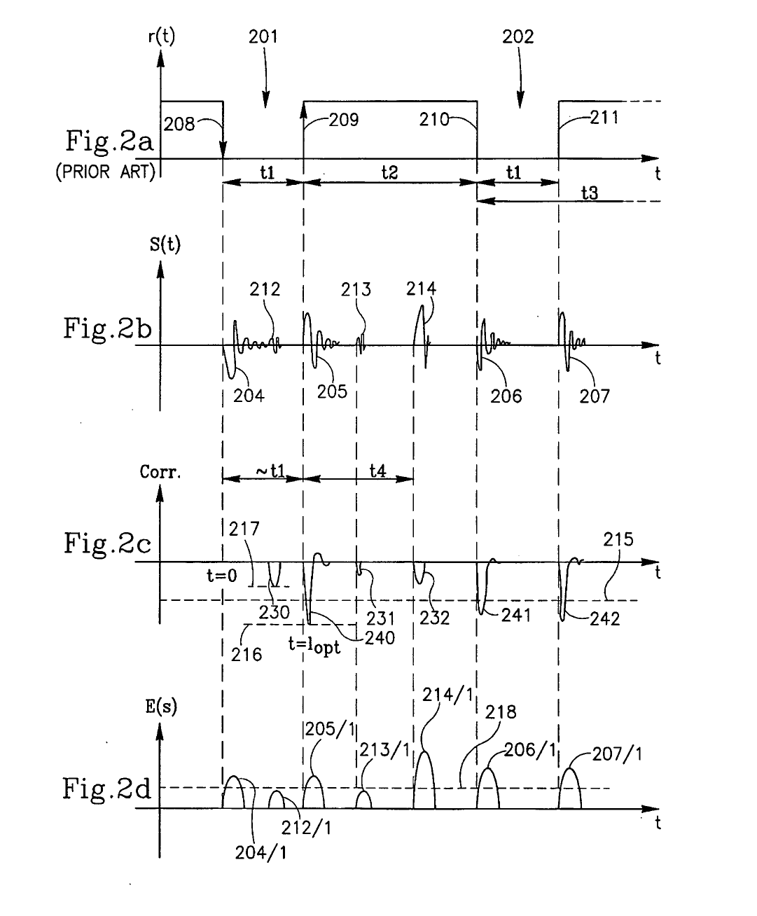

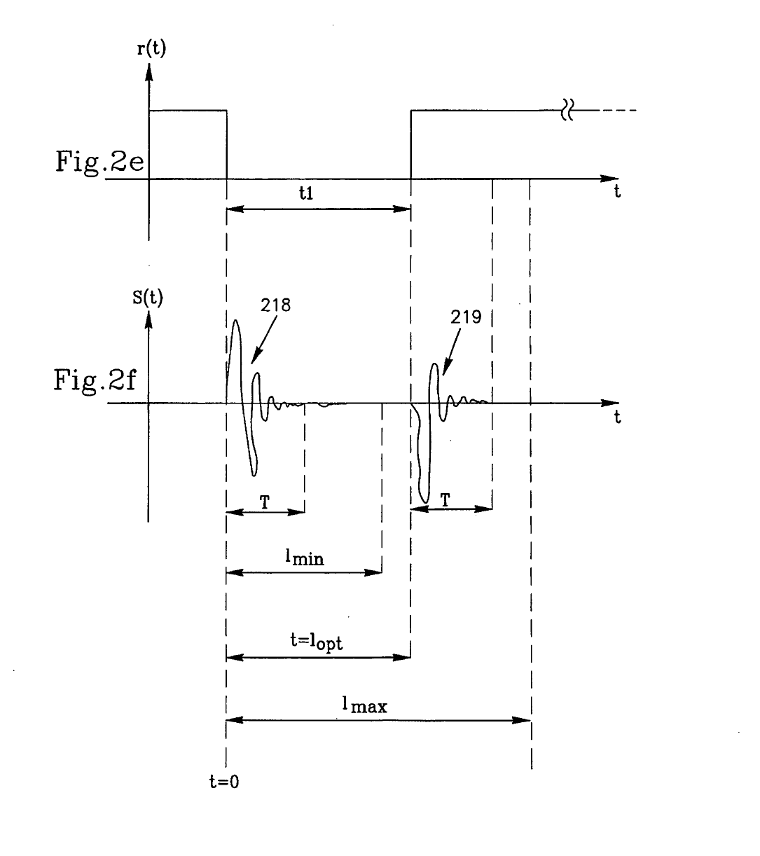

Generally, there is provided a method of detecting an ensemble of pulses in a received signal that may include noise (either constant, periodic, occassionally, intermittently or pulses). The time spacing between the ensemble's pulses may alternate in an expected manner, such as when the ensemble pulses originate from a rotary dial device. The general idea of detecting an ensemble of pulses is demonstrated as by use of FIGS. 2a through 2f. Ensemble pulses that may relate to systems other than telephone systems may be detected likewise.

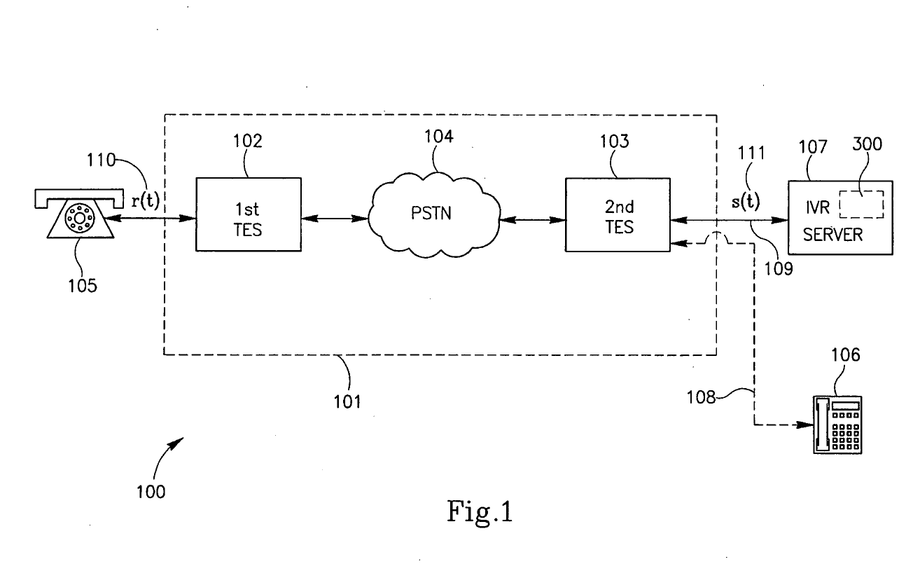

Referring now to FIG. 1, there is schematically illustrated a general telephone system. A typical telephone system such as telephone system 100 may include a telephone exchange system (TES) such as TES 101, which may include a first and a second TESs 102 and 103, respectively, that may be in communication with each other in any signal connective manner, such as over plain simple telephone network (“PSTN”) 104. A plurality of telephone sets and telephonic services rendering servers may be coupled in any signal connective manner, such as hardwired to TES 101. For example, dial telephone (set) 105, DTMF telephone (set) 106 and IVR server 107 are shown hardwired to TES 101 as part of the infrastracture of telephone system 100. Other connections are specifically contemplated, such as wireless and optical connections, so long as signals can be passed between the relevant items or devices.

In general, IVR-enabled systems (such as IVR server 107) are often DTMF-driven systems and dial pulses were traditionally designed to be utilized only for establishing a connection (as part of the first communication phase described hereinbefore) between two telephone sets, or between a telephone set and a telephone service provider. When a telephone connection is established, a voice channel is usually opened (as part of the second communication phase described hereinbefore) between the communicating devices. Sometimes, phone calls may necessitate an interaction between a user of a telephone (a user of dial telephone 105 for example) and the IVR-enabled system (IVR server 107, for example), for rendering services to the telephone user. For example, IVR server 107 may prompt the user of dial telephone 105 to dial the digit “1” for obtaining some information, or “2” for obtaining some technical assistance or “3” for effecting a transaction, and so on. IVR server 107 may introduce to the dial telephone 105 user a spoken-word driven menu or machine-driven audio (collectively referred to herein as spoken-word driven menu), for example, as part of the interaction.

The user of dial telephone 105 may call a second subscriber that may, for example, have a DTMF telephone set such as DTMF telephone 106. Upon lifting the handset of dial telephone 105, TES 102 (which may be regarded, in this case, as a local TES) commences a DC current loop with dial telephone 105. The user of dial telephone 105 may then dial the number of DTMF telephone 106 (as part of the first communication phase described before). While dialing the number of DTMF telephone 106, dial telephone 105 generates a signal shown as r(t) at 110, that includes dial pulses, such as an ensemble or “train” of multiple pulses as shown in FIG. 2a. As may be appreciated by one of skill in the art, pulses such as the pulses shown in FIG. 2a can be easily and distinctively detected, for example by local TES 102, which can therefore easily identify the dialed digits and, consecuently, the dialed number.

After (local) TES 102 identifies the dialed number of DTMF telephone 106, TES 102 may initiate, as part of the second communication phase described before, the opening of a communication path (108) with DTMF telephone 106, possibly via a second TES such as TES 103 (which may be regarded, in this case, as a remote eTES) over PSTN network 104. Depending on the telephone infrastructure and on the telephone subscribers involved in a communication session, a telephone communication session may require the use of one TES. Opening, by TES 102, communication path 108 between dial telephone 105 and DTMF telephone 106 includes blocking the DC current loop previously existed (during the first call phase) between TES 102 and dial telephone 105 and opening a voice path between dial telephone 105 and DTMF telephone 106.

It is assumed that DTMF telephone 106 is a telephone that does not provide telephonic services (as opposed to IVR server 107, for example). Therefore, as exemplified in connection with dial telephone 105 and DTMF telephone 106, generating and forwarding dialing pulses in such cases is traditionally done only once, to establish the voice path between the two (or more) telephones involved in the communication (dial telephone 105 and DTMF telephone 106, in this example). Once the voice path has been established, it may be kept alive as long as desired by the communicating subscribers.

If a user of dial telephone 105 dials the number of IVR server 107, local TES 102 will react in the same way as before, except that, after opening the voice path 109 between dial telephone 105 and IVR server 107, IVR server 107 may ask the user of dial telephone 105 to dial extra characters or symbols which depend on the telephonic application involved and/or on the type of service rendered by IVR server 107. As opposed to the first scenario where a voice path was opened between dial telephone 105 and DTMF telephone 106, responding to the IVR's request by the user of dial telephone 105 will result in generating and forwarding dial pulses towards IVR server 107 over voice path 109. However, as opposed to having to detect (by TES 102, for example) pulses from the signal shown in FIG. 2a, IVR server 107 will have to identify, or recognize, the dialed response within a signal shown as S(t) at 111 that includes an ensemble or “train” of pulses as shown in FIG. 2b. As will be appreciated by one skilled in the art, interpreting ensemble pulses, such as shown in FIG. 2b, is much more difficult comparing to a signal such as signal r(t) of FIG. 2b, because S(t) 111 is a corrupted (greatly distorted waveform of r(t).

Referring again to FIG. 2a (prior art), it shows an exemplary portion of an idealized dial pulse signaling as may be generated by a telephone dial actuator of a dial telephone such as dial telephone 105 of FIG. 1, which may be a mechanical or electronic switch. Periods “t1” and “t2” represent a break period and a make period, respectively. The number of dialed pulses (i.e., the number of break periods) directly relates to the dialed digit. For example, the two exemplary dial pulses, or break periods, 201 and 202 typically represent the digit “2”, though other schemes may be used.

In order to allow distinguishing between dialed digits, the spacing between the last diale pulse of a given digit (the last ensemble pulse associated with the given digit) to the first diale pulse of the next (following) dialed digit is longer than the interval t1+t2 for providing distinctable separation period between consecutive dialed digits. For example, assuming as before that diale pulses 201 and 202 represent the digit 2, the spacing t3 has to be wider than the time interval t1+t2 for allowing distinguishing the digit 2 from a following dialed digit (4, for example). Periods t1 and t2 are determined by communications standards. For example, t1 and t2 may be about 33.33 msec. and 66.66 msec. wide, respectively. Accordingly, a typical dial pulse signaling may have a mean rate of 10 pulses per second (PPS). Communications standards allow deviations within predefined tolerances because t1 and t2 may change, for example as a result of telephones wear and/or deviations in their operating voltages, and so on. Originated from dial pulses, ensemble pulses are directly related to the same dialed digit.

Referring now to FIG. 2b, there is shown an exemplary signal (S(t)) that is consisted of ensemble pulses. Originating from exemplary dial pulses 201 and 202 of FIG. 2a, ensemble pulses 204 through 207 also relate to the dialed digit (2 in this example). FIG. 2b exemplifies a typical effect of passing the dial signal r(t) of FIG. 2a through a voice path (such as voice path 109 in FIG. 1) to a recipient system (such as IVR server 107 of FIG. 1, for example). At the recipient (called) system, diale pulse 201 of FIG. 2a typically appears as transient pulses 204 and 205. Likewise, dial pulse 202 of FIG. 2a typically appears as transient pulses 206 and 207. Therefore, in order for the recipient system to identify diale pulses 201 and 202, the recipient system has, first, to detect ensemble pulses 204 through 207 and secondly, to interpret the detected ensemble pulses 204 through 207 correctly. Referring to the latter example, by “interpret” is meant associating ensemble pulses 204 to 207 to the respective diale pulses and, eventually, to the dialed digit, character or symbol. Pulses such as dial pulses 204 to 207 render the identification of periods t1 and t2 (shown in FIG. 2a), and therefore the identification of dialed digits, difficult, or non-trivial. In addition, noises such as pulses 212 through 214 exacerbate the problem of potential miss-detection of dial pulses.

An ensemble pulse may be either a start or stop pulse, and the expected spacing between a start pulse and a stop pulse is shown, in FIG. 2b, alternating between two values, break period (t1) and make period (t2). For example, ensemble pulse 204 may be considered a start pulse because it represents the leading edge 208 of diale pulse 201 that signals the beginning (start) instant of the diale pulse 201. Ensemble pulse 205 may be considered a stop pulse because it represents the trailing edge 209 of dial pulse 201 that signals the end (stop) instant of dial pulse 201. Likewise, ensemble pulses 206 and 207 are the start and stop pulses, respectively, of dial pulse 202, because ensemble pulse 206 represents the leading edge 210 of dial pulse 202 that signals the beginning (start) instant of dial pulse 202, and ensemble pulse 207 represents the trailing edge 211 of dial pulse 202 that signals the end (stop) instant of dial pulse 202.

Referring now to FIG. 2c, there is shown exemplary correlation results in connection with the exemplary signal S(t) of FIG. 2b. In order to decide that two consecutive pulses belong to the same ensemble of pulses, it is required that correlating them yields a result a that meets a predefined condition or criteria. The predefined condition or criteria may be the lowest correlation value being lower (more negative) than a predefined negative threshold value. In some aspects of the present disclosure, the negative threshold value may be automatically adapted, or adjusted, to prevailing communication conditions. That is, the threshold value may be less stringent in cases where the noise level in the communication path is evaluated to be relatively low. Additionally, the negative threshold value may be automatically adapted or adjusted according to the magnitude of the ensemble pulses.

Pulses 212, 213 and 214, after correlation with pulse 204 (or 205 or 206), are each shown having correlation values (230, 231 and 232, respectively) that are higher (less negative) than the exemplary negative threshold value 215. Therefore, assuming that one pulse (for example, pulse 204) is an ensemble pulse, the other pulse (pulse 212 for example) is not an ensemble pulse. In contradistinction, ensemble pulses 205, 206 and 207, after correlation with pulse 204, are each shown having correlation values (240, 241 and 242, respectively) that are lower (more negative) than the exemplary negative threshold value 215.

A lowest negative correlation value lower than a negative threshold value is sought between two successive ensemble pulses because the leading edge of each dial pulse results in a negative start of the related ensemble pulse, because a leading adge is a negative-going transition (symbolized by an arrow 208 pointing downwards), whereas the trailing edge of each dial pulse results in a positive start of the related ensemble pulse, because a trailing adge is positive-going transition (symbolized by an arrow 209 pointing upwards). For example, a negative-going transition (leading edge) 208 of dial pulse 201 results in a negative start of the related ensemble pulse 204, and positive-going transition (trailing edge) 209 results in a positive start of the related ensemble pulse 204. Therefore, as will be appreciated by one of skill in the art and provided that the (negative) threshold value is properly chosen, correlating between successive ensemble pulses, such as ensemble pulses 204 and 205, will result in a lowest correlation value that is lower (more negative) than a negative threshold value. In an ideal situation, where ensemble pulses 204 and 205 are identical (that is, they form a mirror picture of one another), correlating ensemble pulses 204 and 205 will yield a lowest correlation value with the lowest possible negative value.

In order to decide that two consecutive pulses belong to the same ensemble of pulses, it is also required that the predefined condition or criteria is met for a temporal distance (l), between the correlated ensemble pulses, which resembles the spacing expected for them (break and make periods). For example, pulses 204 and 205 are determined as ensemble pulses because the two conditions are met: (i) Correlating them yields a lowest correlation value (216) that is lower (more negative) than the predefined negative threshold value 215, and (ii) The lowest correlation value 216 is obtained for a temporal distance (lₒₚₜ), between the correlated pulses, which resembles the spacing expected for them (break period t1 in this example).

According to some embodiments correlation may be performed between two successive pulses within a temporal window, the width of which may change between a minimum limit, lₘᵢₙ, and a maximum limit, lₘₐₓ, where lₘᵢₙ<t1<lₘₐₓ, or lₘᵢₙ<t2<lₘₐₓ, depending on which pulses are to be correlated. For example, if, according to some embodiments, pulse 204 is to be correlated with pulse 212 or with pulse 205, the condition lₘᵢₙ<t1<lₘₐₓ will prevail because the expected spacing for these cases is t1 (the break time). However, if pulse 205 is to be correlated with pulses 213, 214 or 206, the condition lₘᵢₙ<t2<lₘₐₓ will prevail because the expected spacing for these cases is t2 (the make period). The values of lₘᵢₙ and lₘₐₓ may be chosen such as to ensure detection of the ensemble pulses.

In a more general case, it is not known in advance if the first detected pulse is an ensemble pulse or a noise pulse. As exemplified by FIG. 2b, pulse 204 is the first detected pulse and pulse 212 is the second detected pulse. Correlating between pulses 204 and 212 yields a value (correlation result) 217 that is higher (less negative) than the threshold value 215. Therefore, at this point, no decision can be made as to whether one of these pulses is potentially an ensemble pulse, because either one of the pulses 204 and 212, or both pulses, may be noise. Therefore, it is assumed at this point that the first detected pulse (in this example pulse 204) is potentially an ensemble pulse. Therefore, according to some embodiments, the first pulse 204 may be further correlated with the next (third) detected pulse 205. As shown in FIG. 2c, correlating between pulses 204 and 205 yields a correlation value that is lower (more negative) than the negative threshold value 215. Therefore, pulses 204 and 205 are both considered to be ensemble pulses, whereas pulse 212 is, consequently, considered as a noise pulse.

According to some embodiments the next detected pulse (213, in this example) may be validated or negated as an ensemble pulse by correlating it with the first validated ensemble pulse (204, in this example). According to some other embodiments pulse 213 may be validated or negated as an ensemble pulse by correlating it with the validated ensemble pulse preceding it (205, in this example).

Correlation between pulses may be implemented by employing equation (1) on corresponding sets of samples of the signal (S(t)):

$${R}_{n} [ l ] = \frac{{\sum }_{n = 0}^{N} X [ n ] * X [ n + l ]}{[ {‖ X ‖}_{0} * {‖ X ‖}_{l} ]} \\ where \\ {‖ X ‖}_{0} = \sqrt{{\sum }_{n = 0}^{N} {X}^{2}} [ n ] and {‖ X ‖}_{l} = \sqrt{{\sum }_{n = 0}^{N} {X}^{2}} [ n + l ] \qquad ( 1 )$$

Rₙ[l] is the normalized correlation value, N is the number of samples used in the correlation and it is chosen such that it covers, or is equivalent to, the period T, the estimated duration of a transient (ensemble) pulse (ensemble pulse 218 of FIG. 2f, for example). Typically, T<t1 (T=10 msec., for example). X[n] is the n^{th} sample in a first N-sample portion of the received signal, and X[n+1] is the n^{th} sample in a second N-sample portion of the received signal, where the first and second portions are to be correlated.

Referring now to FIGS. 2e and 2f, they show an exemplary break period (t1) and relating transient (ensemble) pulses 218 and 219. In equation (1), l is an estimated time spacing (or correlation window) between two correlated pulses. Assuming, for example, that t1 in FIG. 2e equals 33 msec., it may be determined that l may change, for example, within the window 26<l<40 msec., where lₘᵢₙ=26 mSec and lₘₐₓ=40 msec., respectively. lₒₚₜ is an expected spacing between ensemble pulses (218 and 219, for example) for which the correlation value is the lowest. lₒₚₜ may be found by applying equation (2):
lₒₚₜ=argMin{R[l]} (2)

Referring again to FIG. 2d, there is shown an energy distribution of the signal S(t) of FIG. 2b. Reference numerals 204/1, 205/1, 206/1 and 207/1 (in signal E(S)) represent the energy of ensemble pulses 204, 205, 206 and 207, respectively. Reference numerals 212/1, 213/1 and 214/1 (in E(S)) represent the energy of noise pulses 212, 213 and 214, respectively. At times, noise pulses may be more energetic than ensemble pulses.

According to some embodiments pulses are correlated only if their energy exceeds a predefined threshold value, for example threshold value 218. Following this notion, noise pulse 213 will not be correlated with any other pulse because its energy (213/1) is lower than the predefined threshold value 218. Even though the energy of a noise pulse may be greater than the predefined threshold value, the noise pulse will fail the correlation stage (by yielding a too-low correlation value relative to the set threshold 215) or the expected spacing criterion, or both the correlation and spacing criterions. For example, the correlation value and energy associated with noise pulse 214 are shown exceeding the threshold levels 215 and 218, respectively. However, the lowest correlation value of pulse 214 occurs at a spacing t4 that is different from either one of the expected values t1 or t2. Therefore, pulse 214 is not considered an ensemble pulse.

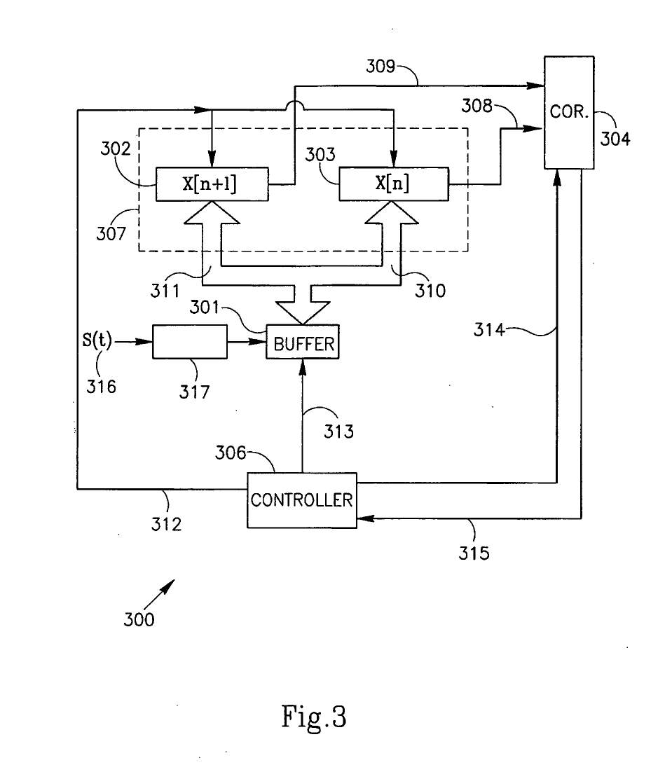

Referring now to FIG. 3, it schematically illustrates the dial pulse detector in accordance with some embodiments of the present disclosure. The input signal S(t) (316) of detector 300, which may be forwarded from a dial telephone (such as dial telephone 105 of FIG. 1) to dial pulse detector 300 over a voice path (such as voice path 109 of FIG. 1) and may resemble signal S(t) of FIG. 2b, is sampled by sampling unit 317 and the sampling values (called samples) may be initially stored in buffer 301, from which N samples may be transferred to a first-in-first-out (“FIFO”) type memory 307. Memory 307 may consist of sub-memories 302 and 303, each of which may store N samples. Each sample n that is stored in memory 303 may have a “mating” sample n+l in memory 302, by which it is multiplied (X[n]*X[n+l]), as part of the correlation process.

As part of the present disclosure, controller 306 may commence cross-correlation between two substantially adjacent correlation windows. Controller 306 may adapt and/or temporarily move each correlation window so that the correlation window is associated with a pulse within the received signal (S(t)). The pulses being correlated may belong to an ensemble of pulses, as described herein.

In operation, controller 306 may commence the correlation by ordering (313) buffer 301 to initially transfer (310) N successive samples to sub-memory 303 and different N successive samples to sub-memory 302 (311). The spacing between the samples stored in memories 302 and 303 is l (see equation (1)). Then, controller 306 may order (312) sub-memories 302 and 303 to transfer to correlator 304 one sample at a time (309 and 308, respectively), while, after each transfer, controller 306 may cause correlator 304 (314) to multiply output 308 by output 309, and to transfer (315) to controller 306 intermediate calculation results that are associated with a specific correlation calculation. Controller 306 may sum up the intermediate results to obtain a correlation value for a specific l within the correlation window lₘᵢₙ÷lₘₐₓ, and store the correlation value, for example in its internal memory (not shown). Alternatively, correlator 304 may complete the calculations associated with a given correlation and only then forward to controller 306 the final calculation result.

Controller 306 may then change the value of l from lₘᵢₙ to lₘₐₓ, by a predefined step, by causing buffer 301 to transfer the same initial N samples to memory 303 and additional N new successive samples to memory 302 that correspond to the new values of l. Controller 306 may thus cause correlator 304 to perform new calculations for each value of l, whereby to obtain another correlation result (Ri) that is also associated with the initial set of N samples. The initial N samples may relate, for example, to pulse 218 of FIG. 2f and the values of l may be determined in respect of a zero-time reference (t0, in FIG. 2f) which is substantially the instant at which a pulse, whether an ensemble pulse (pulse 218) or noise pulse, is detected. Controller 306 may cause the latter described process to repeat for other detected pulses by causing buffer 301 to load into memory 303 the same initial N of samples or use a different set of N samples. By “additional N new successive samples” is meant a set of N samples that includes at least one new sample that was not used in a former correlation. As the value of l changes from a first value (l₁) to a second value (l₂), at least some of the samples may be used for both l₁ and l₂.

According to some embodiments controller 306 may instruct correlator 304 to operate (314) only if samples that are stored in memory 303 are indicative of a pulse. For this purpose, controller 306 may instruct memory 303 (312) to forward to it the samples currently stored therein (310). An indication to a pulse being received may be several samples having magnitudes where each magnitude is greater than a predefined threshold value. Controller 306 may identify and distinguish between ensemble and non-ensemble pulses by comparing their respective lowest correlation values to a negative threshold value, and their respective lₒₚₜ to the expected temporal spacing. According to some embodiments controller 306 may further interpret the detected ensemble pulses as a corresponding dialed digit, character or symbol, for example by counting the number of break periods.

Dial pulse detector 300 may employ the method disclosed herein for detecting and identifying even the first generated dial pulse without requiring any preamble pulses or employing a training or learning procedure of any kind, and regardless of the digit, character or symbol, being dialed.

In accordance with the present disclosure, the signal S(t), which typically contains transient pulses such as the start and stop pulses of FIG. 2b, may be forwarded to dial pulse detector such as dial pulse detector 300, where the signal S(t) can be processed and analyzed, and dialed digits/characters/symbols may be identified. Thereafter, a corresponding IVR-compatible data or signal, which relates to the identified dialed digit, character or symbol, may be forwarded from detector 300 to any system or apparatus that can use this data or signal.

The signal S(t) (316) may be continuously monitored by dial pulse detector 300, and every probable pulse may be stored in its buffer 301, with its detection instant. The term “probable” generally refers to a portion of the received signal having some energy that does not necessarily exceed the energy predefined threshold value. Every detected ensemble pulse may be tagged either as start or stop pulse relative to the preceding pulse, based on the time lapsing (t1 or t2, whichever the case may be) from its preceding ensemble pulse.

Based on the correlation results and temporal criterion (the expected spacing between ensemble pulses), controller 306 may validate probable pulses as ensemble pulses. Detector 300 may calculate the number of ensemble pulses and interpret this number as the dialed digit. For example, if detector 300 detects an ensemble of six pulses, it may determine that the digit “3” (6/2) was dialed, and so on.

It is noted that any given probable pulse may be determined either as an ensemble or as a noise pulse by correlating the probable pulse with any already detected ensemble pulse within that ensemble and regardless of the relative temporal locations of the pulses. The latter capability is obtained because, typically, there are insignificant changes, if at all, in the parameters/characteristics of communication path during a given telephone call. As a result of this, start and stop pulses are expected to have similar signal characteristics; that is, they are expected to be highly correlated to one another.

The analog signal S(t) (316) monitored by detector 300 may be digitized and the resulting digital signal may be processed, analyzed and interpreted using well-known digital signal processing (“DSP”) tools. In some embodiments the dial, or pulse, detector 300 may be implemented as a “stand-alone” apparatus. In other embodiments, detector 300 may be affiliated, embedded or incorporated into a IVR-enabled system or apparatus, or the IVR functionality of a system or apparatus may be enhanced by adding to it the functionality of dial detector 300. FIG. 1 exemplifies incorporation of a dial pulse detector, such as dial pulse detector 300, into IVR enabled server 107.

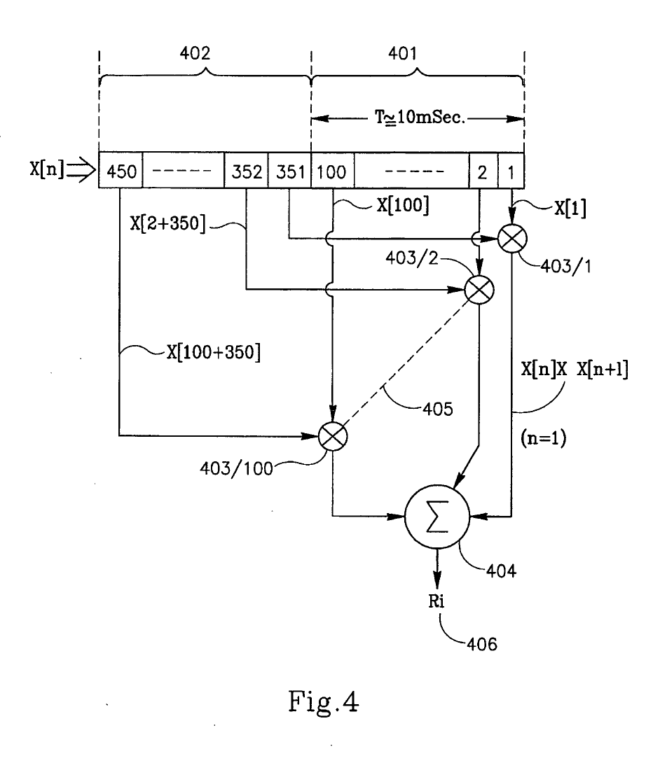

Referring now to FIG. 4, an exemplary implementation of a correlator is schematically illustrated according to some embodiment of the present disclosure. In order to detect ensemble pulses, samples of the input analog signal (such as S(t) of FIG. 2b or 3) are first taken at a predetermined sampling rate.

Assuming that a signal being involved in the correlation process (for example S(t) of FIG. 2b or 3) is sampled 10,000 times per second (every Δt=0.1 msec.) and the expected transient time T is 10 msec., (N=) 100 samples, numbered 1 to 100, may be loaded, or entered, into shift register 401. Assuming a break and make periods of 30 msec. and 60 msec., respectively, lₘᵢₙ may be 25 msec. and 50 msec., respectively, which are equivalent to (25/0.1=) 250 and (50/0.1=) 500 samples, respectively. Since a starting pulse is expected to be received first at the dial detector, and then followed by a stop pulse, the next successive 100 samples to be loaded into shift register 402 may be samples 351 to 450. Samples 1 to 100 do not necessarily have to be the first 100 samples of S(t) but, rather, they may relate to a first detected pulse in S(t), which may start, for example, after 650 first samples. Pursuant to the later example, if a stop pulse has been detected, the next pulse is expected to be a start pulse and, therefore, the initial spacing (i.e., lₘᵢₙ) between the respective 100 samples may be set to 500 samples.

Correlation of the signal involves multiplications (by multipliers 403/1 to 403/100, referred to by 405) of samples in register 401 with respective samples in register 402 and summing-up (404) the multiplication results. Summing-up (404) the outputs of multipliers 403/1 to 403/100 results in a first correlation result R1 (406). Likewise, samples 1 to 100 may be correlated with a different set of 100 samples (for example samples 355 to 454) to obtain a second correlation result R2 (not shown). The latter process may be repeated as many times as required, until a series of correlation results (R1, R2, R3, and so on) is obtained, which corresponds to respective values of l within the window lₘᵢₙ÷lₘₐₓ. Then, the lowest value (Rₘᵢₙᵢₘᵤₘ) among the series of correlation results R1, R2, R3, and so on, may be registered in, and analyzed by, controller 306. As stated hereinbefore, if Rₘᵢₙᵢₘᵤₘ is lower than a predetermined negative threshold value and Rₘᵢₙᵢₘᵤₘ occurs for l that meets the condition lₘᵢₙ<l<lₘₐₓ, then controller 306 may determine that the correlated pulses are ensemble pulses.

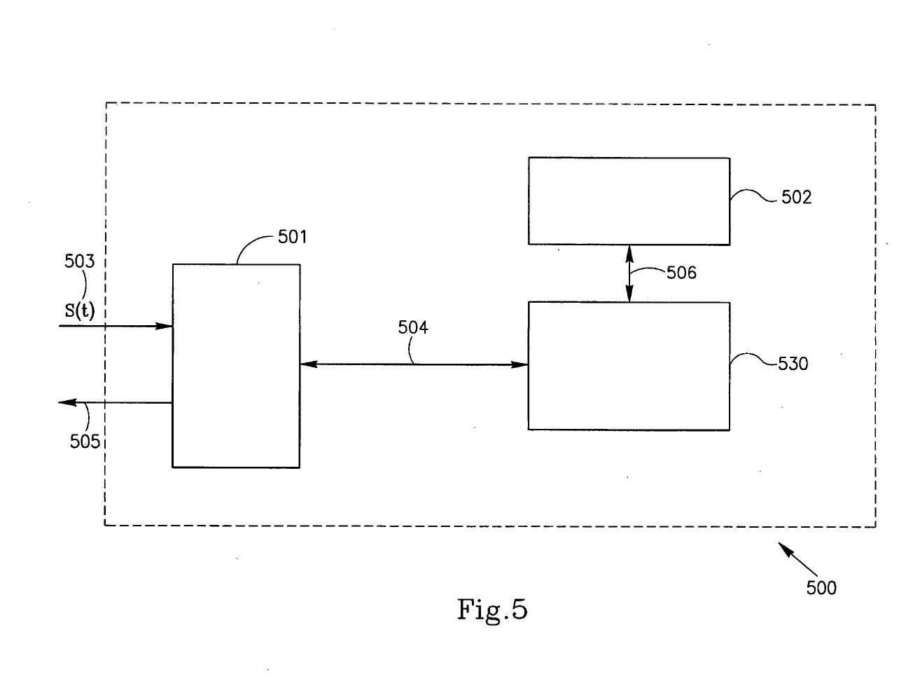

Referring now to FIG. 5, it schematically illustrates an interactive terminal equipment (“ITE”) according to some embodiments of the present disclosure. The ITE (500) may include a communication interface 501 for bidirectional communication of signals associated with a telephone call, a memory 502 for storing, among other things, a spoken-word driven menu, and a dial pulse detector 530, such as the dial pulse detector 300 shown and described in relation to FIG. 3.

Dial pulse detector 530 may detect in a received signal (S(t)) 503 a dialed digit, character or symbol, by detecting an ensemble of (alternating start and stop) pulses that are related to the dialed digit, character or symbol. Dial pulse detector 530 may detect the ensemble pulses by performing correlation between pulses in the signal and by relating pulses to the ensemble if the correlation process outputs a lowest (or highest, depending on whether correlation is applied to even or odd pulses, as explained hereinbefore) value that is lower (or higher) than a predefined negative (or positive) threshold value, and the spacing between the pulses being correlated is an expected spacing (within some tolerance).

The controller of dial pulse detector 530, which may function like controller 306 in FIG. 3, may interpret the detected ensemble as a dialed digit, character or symbol, and perform a task corresponding to the detected dialed digit, character or symbol. The task that may be performed by dial pulse detector 530 may include forwarding (504) to a calling party, through interface 501, a signal (505) representative of a verbal response that may be selected (506) from the spoken-word driven menu stored in memory 502. The task that may be performed by dial pulse detector 530 may include other activities, such as relaying the call session to a requested, or third, party.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An interactive terminal equipment, comprising:
a communication interface for bidirectional communication of telephone call related signals;
a memory for storing a spoken-word driven menu; and
a dial pulse detector adapted to identify a dialed digit in a signal received through said communication interface by detecting ensemble pulses in said signal and interpreting said ensemble pulses, and to perform a task corresponding to the identified dialed digit.

2. The interactive terminal equipment of claim 1, wherein the dial pulse detector comprises:
a sampling unit for sampling the received signal;
a buffer memory for storing therein samples of said received signal;
a correlator for correlating between corresponding sets of samples; and
a controller adapted to cause said sampling unit to sample said received signal, store the samples in said buffer and to transfer samples from said buffer to said correlator.

3. The interactive terminal equipment of claim 2, wherein detecting comprises performing correlation between pulses in the signal and relating pulses to the ensemble if the correlation result meets a predefined criteria.

4. The interactive terminal equipment according to claim 1, wherein the task comprises forwarding to the communication interface a signal representative of a verbal response selected from the spoken-word driven menu.

5. A dial pulse detector for detecting ensemble pulses in a received signal wherein the spacing between at least two ensemble pulses is an expected spacing within some tolerance, comprising:
a sampling unit for sampling a received signal;
a buffer memory for storing therein samples of said received signal;
a correlator for correlating between sets of samples; and
a controller adapted to identify a dialed digit in said signal received by detecting ensemble pulses in said received signal and interpreting said ensemble pulses.

6. The dial pulse detector according to claim 5, wherein detecting comprises transferring corresponding samples to the correlator, enabling the correlation and relating correlated pulses to the ensemble if the correlation result meets a predefined criteria.

7. The dial pulse detector according to claim 6, wherein the correlation is performed between two successive pulses.

8. The dial pulse detector according to claim 6, wherein the correlation is performed between a given detected ensemble pulse and other pulses.

9. The dial pulse detector according to claim 8, wherein the given detected ensemble pulse is a first detected ensemble pulse.

10. The dial pulse detector according to claim 6, wherein ensemble pulses are alternating start and stop pulses of telephonic dialed pulses, and the spacing between said ensemble pulses alternates between a break period and a make period.

11. The dial pulse detector according to claim 7, wherein the correlation between two pulses is performed within a temporal window, the width of which is defined by a low boundary, lₘᵢₙ, and a high boundary, lₘₐₓ, where lₘᵢₙ<t1<lₘₐₓ, or lₘᵢₙ<t2<lₘₐₓ, depending on the pulses being correlated.

12. The dial pulse detector according to claim 6, wherein pulses are correlated only if their energy level exceeds a predefined threshold value.

13. The dial pulse detector according to claim 10, further comprising interpreting the ensemble pulses to corresponding dialed digit.

14. The dial pulse detector according to claim 13, further comprising forwarding a signal representative of the dialed digit to an interactive voice response enabled system.

15. A pulse detector for detecting a plurality of pulses within a data stream representing a received signal, comprising;
a controller adapted to cross-correlate two substantially adjacent correlation windows.

16. The pulse detector according to claim 15, wherein the controller is adapted to perform correlation between two successive pulses.

17. The pulse detector according to claim 15, wherein the controller is adapted to perform correlation between a given pulse and another pulse.

18. The pulse detector according to claim 15, wherein the pulses include alternating start and stop pulses of a telephone dialed pulse(s).

19. The pulse detector according to claim 18, wherein the controller is further adapted to interpret pulses as corresponding dialed digit.

20. The pulse detector according to claim 15, wherein the controller is adapted to correlate pulses only if their energy level exceeds a threshold value.

21. The pulse detector according to claim 19, wherein the controller is further adapted to forward a signal representative of the dialed digit to an interaction voice response enabled system.

22. The pulse detector according to claim 21, wherein the controller is incorporated into the interactive voice response enabled system.

23. The pulse detector according to claim 21, wherein the interaction voice response enabled system is remote to the controller.

24. The method of detecting ensemble pulses in a received signal wherein the spacing between the ensemble pulses alternate in an expected manner, comprising:
performing correlation between pulses in said received signal and relating pulses to said ensemble if the correlation result complies with a predefine criteria and the spacing between the pulses being correlated, for which said predefine criteria was met, is substantially the spacing expected between said pulses.

25. The method according to claim 24, wherein the correlation is performed between two successive pulses.

26. The method according to claim 24, wherein the correlation is performed between a given detected ensemble pulse and the other pulses.

27. The method according to claim 26, wherein the given detected ensemble pulse is the first detected ensemble pulse.

28. The method according to claim 24, wherein the ensemble pulses are alternating start and stop pulses of telephone dialed pulses.

29. The method according to claim 25, wherein the correlation between two pulses is performed within a temporal window, the width of which is defined by a low boundary, lₘᵢₙ, and a high boundary, lₘₐₓ, where lₘᵢₙ<t1<lₘₐₓ, or lₘᵢₙ<t2<lₘₐₓ, depending on which pulses are to be correlated.

30. The method according to claim 24, wherein pulses are correlated only if their energy level exceeds a threshold value.

31. The method according to claim 28, further comprising interpreting ensemble pulses as corresponding dialed digit.

32. The method according to claim 31, further comprising forwarding a signal representative of the dialed digit to an interactive voice response enabled system.

33. A method of detecting a plurality of pulses within a data stream representing a received signal, comprising:
cross-correlating two substantially adjacent correlation windows.

34. The method according to claim 33, wherein the correlation is performed between two successive pulses.

35. The method according to claim 33, wherein the correlation is performed between a given pulse and another pulse.

36. The method according to claim 35, wherein the given pulse is a first detected pulse.

37. The method according to claim 33, wherein pulses are alternating start and stop pulses of a telephone dialed pulse(s).

38. The method according to claim 37, further comprising interpreting pulses as corresponding dialed digit.

39. The method according to claim 33, wherein pulses are correlated only if their energy level exceeds a threshold value.

40. The method according to claim 39, further comprising forwarding a signal representative of the dialed digit to an interactive voice response enabled system.
